(19) United States
(12) Patent Application Publication
(10) Pub. No.: US 2004/0243575 A1
(43) Pub. Date: Dec. 2, 2004

(54) Information searching system

(75) Inventor: Tadashi Ohashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/886,698

(22) Filed: Jul. 9, 2004

Related U.S. Application Data
(63) Continuation of application No. PCT/JP02/00220, filed on Jan. 16, 2002.

(51) Int. Cl. G06F 7/00

(52) U.S. Cl. 707/3

(57) ABSTRACT

A plurality of servers are interconnected via a network. A storage device stores information. In a registration information DB, meta data which represents the attribute of the information stored in the storage device is registered. This meta data is broadcast to other servers. A query statement input for information search is transferred to an appropriate server based on the meta data received form other server. An agent that receives the query statement extracts the corresponding information from the storage device according to the meta data registered to the registration information DB, and provides the extracted information to a client.

### CROSS REFERENCE TO RELATED APPLICATION

This is a continuation of an International Application No. PCT/JP02/00220, which was filed on Jan. 16, 2002.

### BACKGROUND OF THE INVENTION

1. Field of the Invention

The present invention relates to a system searching for stored information, and a system displaying stored information. In addition, the present invention may be applicable to a system which has a plurality of servers.

2. Description of the Related Art

In recent years, various items of information are generated/edited by a computer, and stored in a storage device as electronic data. These electronic data are published, for example, on a Web page, etc. However, the amount of published information is very large, and the information items are not necessarily stored under uniform rules. Therefore, it is not easy to search for desired information.

When desired information is searched, an access is first made to a Web page that seems to be associated with the desired information. At this time, the Web page can be searched by transmitting a keyword associated with the desired information to a search engine provided on a network. Then, the desired information is obtained from the Web page.

With this system, however, certain experience and technique are required when absolutely desired information is searched. For example, an operation for sequentially inputting appropriate keywords using a search function provided by a Web page is necessary. Therefore, especially, a user who is unfamiliar with information search cannot securely obtain desired information in some cases. Additionally, since a load is concentrated on a search engine with this system, a response to a search request is frequently degraded. Furthermore, information items are not stored under uniform rules. Therefore, it cannot be said that a database is transparent for a user.

### SUMMARY OF THE INVENTION

An object of the present invention is to provide an information searching system that can easily obtain desired information.

The information searching system according to the present invention has a plurality of information providing servers, and each of the plurality of information providing servers comprises following device or unit. Namely, each of the information providing servers comprises: a storage device which stores information; a generating unit generating meta data which represents the attribute of information stored in the storage device; a transferring unit transferring the meta data generated by the generating unit to other information providing server; a detecting unit detecting an information providing server corresponding to a given query statement based on meta data transferred from other information providing server; a query statement transferring unit transferring the query statement to the information providing server which is detected by the detecting unit; and an extracting unit extracting the information requested by the query statement which is transferred from other information providing server based on the meta data generated by the generating unit.

In this system, meta data for information stored in the storage device of a certain information providing server (hereinafter referred to as a first information providing server) is shared by the plurality of information providing servers. Accordingly, when a query statement for requesting information stored in the storage device is input with an arbitrary one of the plurality of information providing servers which share the meta data, the query statement is transferred to the first information providing server based on the meta data. Then, the first information providing server extracts the information corresponding to the received query statement from the storage device according to the meta data.

### BRIEF DESCRIPTION OF THE DRAWINGS

FIG. 1 shows the configuration of an information searching system according to an embodiment of the present invention;

FIGS. 2A and 2B exemplify the definition of a hierarchical structure;

FIG. 3 shows the hierarchical structure for storing information;

FIG. 4 exemplifies meta data generated when information is stored in a server;

FIG. 5 explains a link set for meta data;

FIG. 6 exemplifies meta data stored in a registration information DB;

FIG. 7 shows a sequence when information is stored in a server;

FIG. 8 shows a sequence when information is searched;

FIG. 9 shows how to transfer an input query statement;

FIG. 10 explains the hierarchical structure of registration information, and IP address assignment;

FIG. 11 shows how to transfer registration information;

FIG. 12 explains the information generated for each business process;

FIG. 13 explains the registration information of information generated for each business process;

FIG. 14 exemplifies URL assignment;

FIG. 15 exemplifies meta data in the configuration shown in FIG. 14;

FIG. 16 exemplifies a display of the hierarchical structure of information stored in a server;

FIG. 17 is a flowchart showing the operations of a server (No. 1);

FIG. 18 is a flowchart showing the operations of the server (No. 2);

FIG. 19 is a flowchart showing the operations of the server (No. 3);

FIG. 20 is a block diagram showing a computer which executes a program describing the functions of the present invention; and

FIG. 21 explains a method providing a software program according to the present invention.

### DESCRIPTION OF THE PREFERRED EMBODIMENTS

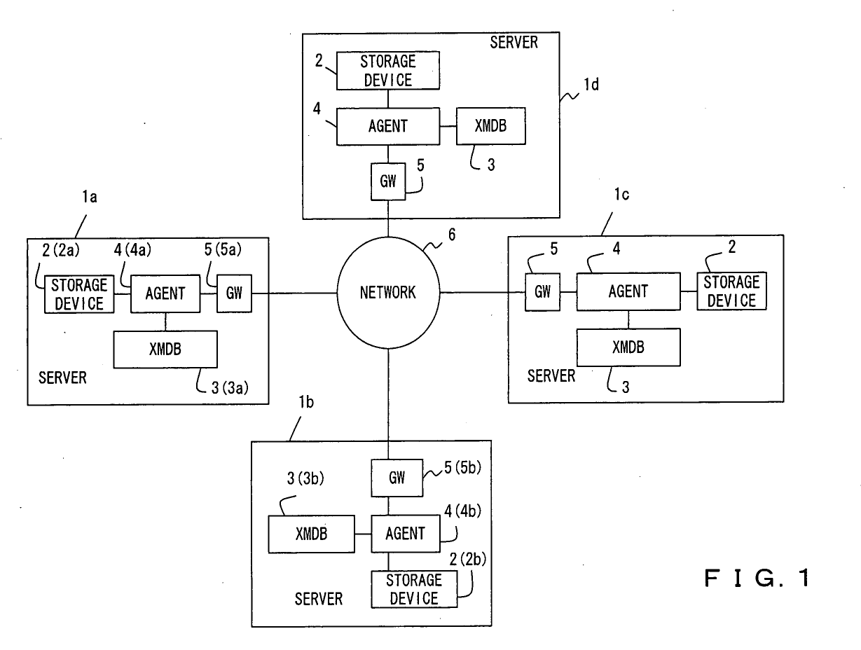

FIG. 1 shows the configuration of an information searching system according to an embodiment of the present invention. Here, servers are arranged at a plurality of sites, and the servers are interconnected via a network.

Each of the servers 1a to 1d stores information to be searched, and comprises a function for providing corresponding information according to search request. Each of the servers 1a to 1d is configured by one or a plurality of computers. Additionally, each of the servers 1a to 1d comprises a storage device 2, a registration information DB (XMDB: XML Database) 3, an agent 4, and a gateway (GW) 5. Furthermore, each of the servers 1a to 1d operates as a client when searching for information stored in other server.

The storage device 2 is a device storing electronic data, such as a hard disk, an optical disk device, a magnetic tape device, etc. In the storage device 2, information generated/edited by corresponding one of the servers 1a to 1d is stored.

The registration information DB 3 is a database for managing information (meta data) associated with the information stored in the storage device 2. Note that meta data includes information representing the hierarchical structure of information stored in a server. Although the meta data is not particularly limited, it is assumed to be written in an XML (eXtensible Markup language) here.

When information is stored in the storage device 2, the agent 4 generates meta data of the information and writes the generated meta data to the registration information DB 3. Additionally, when a query statement for information search is input, the agent 4 converts the statement into an XML document and passes the document to the gateway 5. Upon receipt of the query statement from a client, the agent 4 extracts the information instructed by the query statement from the storage device 2 by referencing the meta data stored in the registration information DB 3, and provides the extracted information to the client. Although the agent 4 is not particularly limited, it is implemented, for example, by a JAVA virtual machine.

The gateway 5 broadcasts the meta data (or part of the meta data) stored in the registration information DB 3 to the other servers. Additionally, the gateway 5 transfers the query statement that is converted into the XML document to the server instructed by the meta data.

Although the network 6 is not particularly limited, it is implemented, for example, by a TCP/IP network.

In the above described information searching system, information to be searched is stored in the storage device 2 as an element in a predetermined hierarchical structure. Then, meta data corresponding to that information is stored in the registration information DB 3, and the meta data (or part of the meta data) is broadcast to the other servers. Here, the meta data indicates the attribute of corresponding information, to be more specific, registration information when the corresponding information is stored in the storage device 2.

For example, when the information generated by the server 1a is stored in a storage device 2a, meta data of that information is first generated by an agent 4a and stored in a registration information DB 3a. Then, the meta data or part of the meta data is broadcast to the servers 1b to 1d via a gateway 5a. As a result, the servers 1a to 1d can share the meta data or part of the meta data of the information to be searched.

In the meantime, for example, when a query statement (search request) for searching for information is input with the server 1b that operates as a client, an agent 4b converts the query statement into an XML document, and passes the XML document to a gateway 5b. The gateway 5b references the received meta data (and/or a registration information DB 3b), and detects the storage location of the information instructed by the query statement that is converted into the XML document. Assuming that the corresponding information is stored in the server 1a at this time, the server 1b transfers the query statement to the server 1a. Upon receipt of the query statement via the gateway 5a, the agent 4a of the server 1a references the registration information DB 3a, extracts the information corresponding to the received query statement from the storage device 2a, and transmits the extracted information to the server 1b that operates as the client.

As described above, in the information searching system according to this embodiment, meta data or part of the meta data of information to be searched is shared by the servers 1a to 1d. An input query statement is transferred to an appropriate server. The server that receives the query statement provides the information corresponding to the query statement. Accordingly, a load of information search is not concentrated on a particular server, and a satisfactory response to a search request can be expected.

Information to be searched is, as described above, stored in the storage device 2 as one of information elements in a predetermined hierarchical structure. This hierarchical structure is described below. The following embodiment assumes the case where information about a commodity or a product is shared by a plurality of companies.

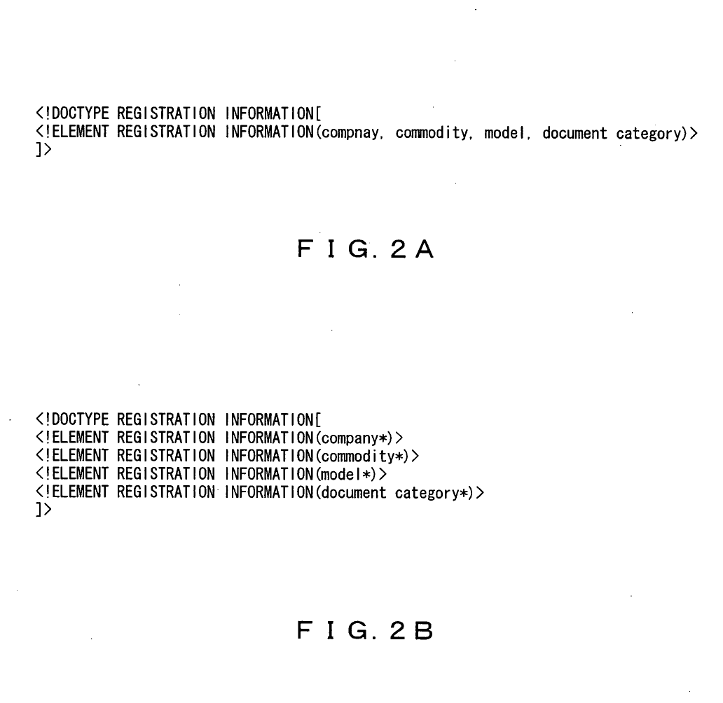

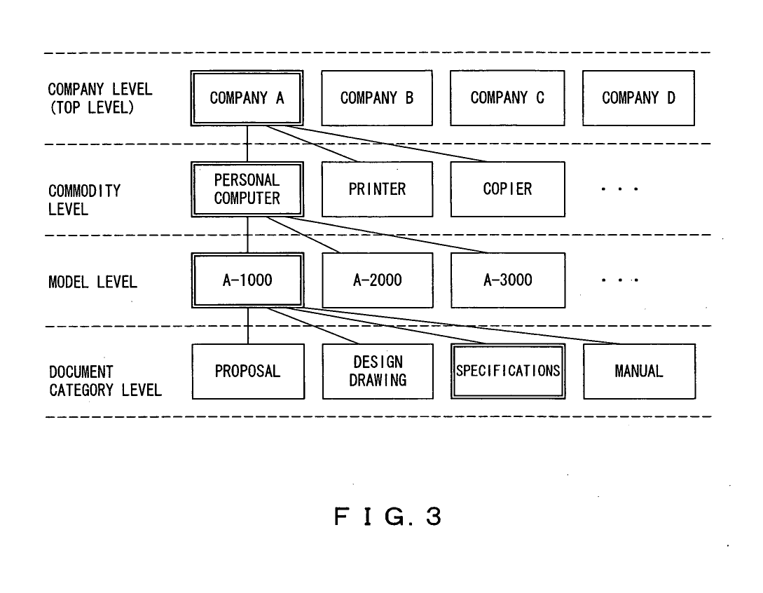

The hierarchical structure is, for example, a semantic Web (or a semantic data model), and is predefined. The definition of the hierarchical structure is written, for example, in an XML, and is stored in an area that can be referenced by agents 4a to 4d. A hierarchical structure written with DTD (Document Type Definition) of the XML is exemplified in FIGS. 2A and 2B. Here, assume that the hierarchical structure is configured by a company level, a commodity level, a model level, and a document category level as shown in FIG. 3. Additionally, one or a plurality of attributes are prepared for each of the levels. By way of example, for the document category level, a proposal, a design drawing, specifications, a manual, etc. are prepared as attributes.

When an information registrant registers a generated document to a server, he or she declares the attribute of each of the levels. For example, if specifications of a model A-1000 of personal computer of company A is generated and stored in a server, “company=A”, “commodity=personal computer”, “model=A-1000”, and “document category=specifications” are declared as registration information.

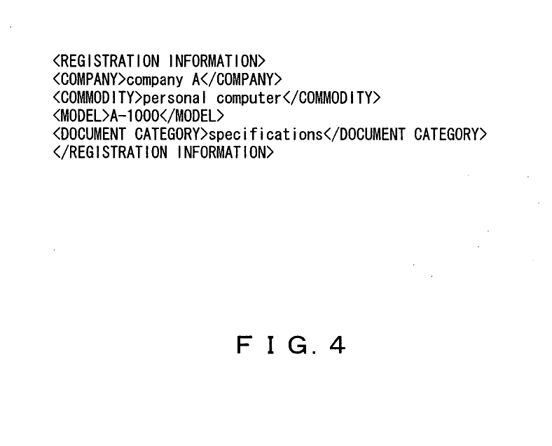

The agent 4 generates meta data of the generated information based on this declaration. Namely, for example, if a generated document is registered to the storage device 2a of the server 1a, the agent 4a generates the meta data of that document. Specifically, when the above described declaration is made, meta data shown in FIG. 4 is generated. Notice that meta data is written in the XML.

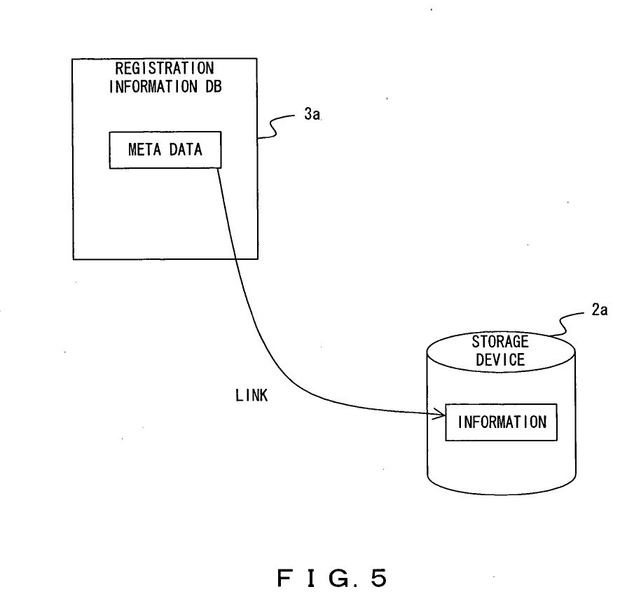

The meta data thus generated is stored in the corresponding registration information DB 3. At this time, a link from the meta data to the storage address of the corresponding information is established. Namely, if generated information is stored in the storage device 2a, meta data associated with that information is generated and registered to the registration information DB 3a as shown in FIG. 5, and the link from the meta data to the storage address of the above described information is established. This link may be, for example, a simple link or an extended link.

When meta data is registered to the registration information DB 3 in this way, a corresponding gateway 5 broadcasts the meta data or part of the meta data to the other servers. Namely, supposing that the meta data shown in FIG. 4 is registered to the registration information DB 3a, the gateway 5a transmits the whole or part of the meta data shown in FIG. 4 to the gateway 5 of each of the servers 1b to 1d. Here, if part of the meta data is broadcast, data of one or a plurality of levels are selected sequentially from the data of the highest level of the hierarchical structure shown in FIG. 3. For example, if only the data of the highest level of the meta data shown in FIG. 4 is broadcast, “<COMPANY>company A</COMPANY>” is selected.

When meta data is broadcast, address information of a source server of the meta data is added to the meta data. Namely, when meta data is broadcast from the server 1a to the servers 1b to 1d, address information for identifying the server 1a is added to the meta data. Here, the address information may be, for example, a URL (Uniform Resource Locator) assigned to the server 1a.

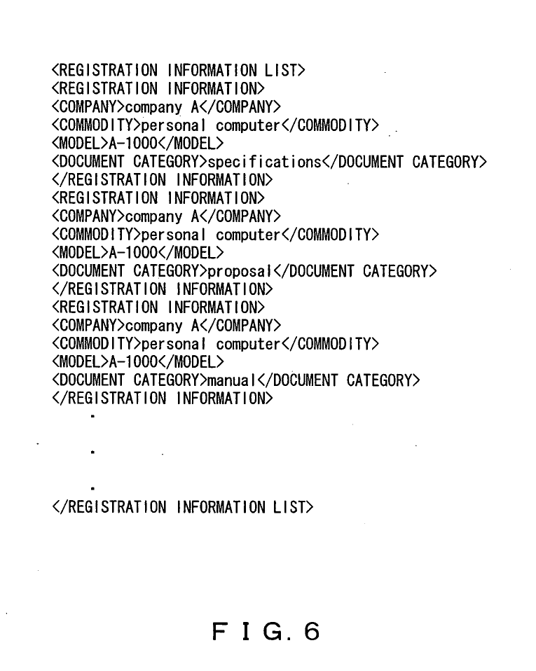

As described above, in the information searching system according to this embodiment, each time information is stored in a server, meta data corresponding to that information is generated and registered to a registration information DB 3. Accordingly, if a plurality of pieces of information are stored in a certain server, a plurality of pieces of meta data are registered to the corresponding registration information DB 3 as shown in FIG. 6. In the example shown in FIG. 6, meta data of the specifications, the proposal, and the manual of the model A-1000 are registered. Here, links to the storage address of the specifications, the storage address of the proposal, and the storage address of the manual are respectively established in each piece of the meta data.

A method searching for information registered as described above is described next.

An information searcher inputs a query statement as a search request by using an arbitrary one of the servers 1a to 1d, when searching for information stored in the servers 1a to 1d. Here, the following query statement is assumed to be input. query statement: “desires to obtain specifications of A-1000 of personal computer of company A”

The input query statement is passed to the corresponding agent 4. Here, the agent 4 comprises a document analysis function and a dictionary function. The agent 4 breaks down the given query statement, and interprets the contents of the meanings of respective words. Specifically, the agent 4 breaks down the query statement into “company A”, “personal computer”, “A-1000”, “specifications”, and “desires to obtain”, and interprets the respective meanings.

Then, the agent 4 examines whether or not a word belonging to “company”, “commodity”, “model”, or “document category” exists among the words obtained by the above described breaking down process. If such a word is found, it is written with an XML tag. As a result, the following tags are obtained in this example.

company tag:

<COMPANY>company A</COMPANY>

commodity tag:

<COMMODITY>personal computer</COMMODITY>

model tag:

<MODEL>A-1000</MODEL>

category tag:

<DOCUMENT CATEGORY>specifications</DOCUMENT CATEGORY>

The tags generated based on the query statement are passed to a corresponding gateway 5. The gateway 5 searches for meta data which match or correspond to the received tags, and extracts the address information added to the meta data. Then, the tags generated based on the query statement are transferred according to the address information. Here, the address information designates the source server of the meta data. In this way, the tags generated based on the query statement are transferred to the source server of the corresponding meta data.

The agent 4 of the server that receives the tags, that are generated based on the query statement, searches for matching or corresponding meta data in the corresponding registration information DB 3. Then, the tree structure represented by the meta data is traced, so that a previously established link is detected, and the storage location of the storage device 2, which is specified by that link, is accessed. As a result, the server provides the information specified by the query statement.

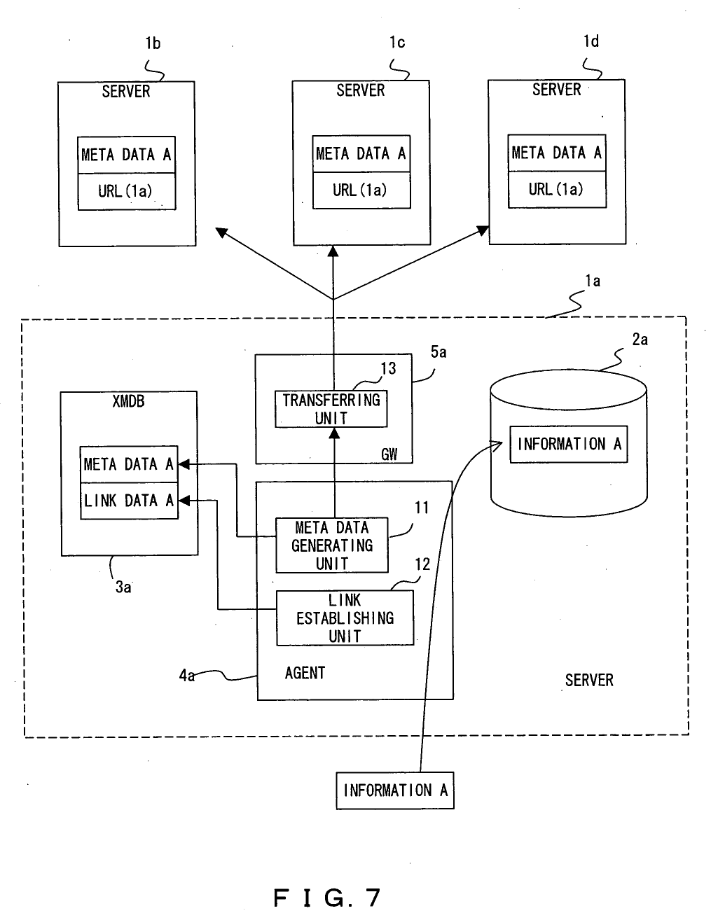

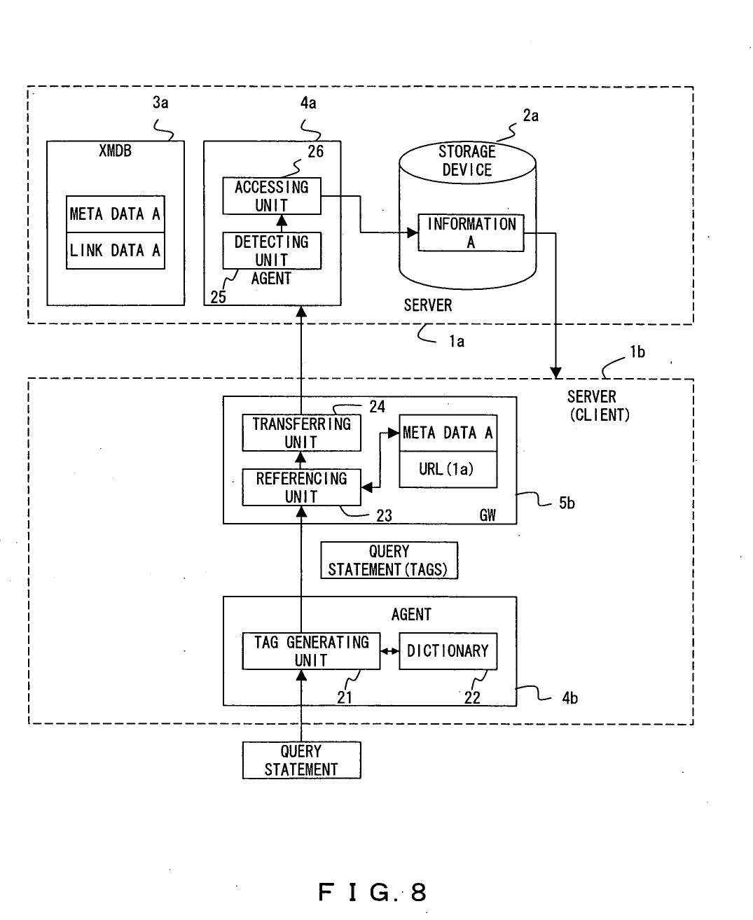

A specific example is described with reference to FIGS. 7 and 8. FIG. 7 shows a sequence when information is stored in a server. In the meantime, FIG. 8 shows a sequence when information stored in a server is searched.

In FIG. 7, when information A is stored in the storage device 2a, a meta data generating unit 11 generates the meta data (meta data A) of the information A, and registers the generated meta data to the registration information DB 3a. Additionally, a link establishing unit 12 generates link data A which designates the storage address of the information A. Here, the link data A is corresponded to the meta data A. Then, a transferring unit 13 broadcasts the meta data A that is generated by the meta data generating unit 11 to the servers 1b to 1d. At this time, also the URL of the server 1a is notified to the servers 1b to 1d along with the meta data A. As described above, when the information A is stored in the storage device 2a, the meta data A is broadcast to the servers 1b to 1d.

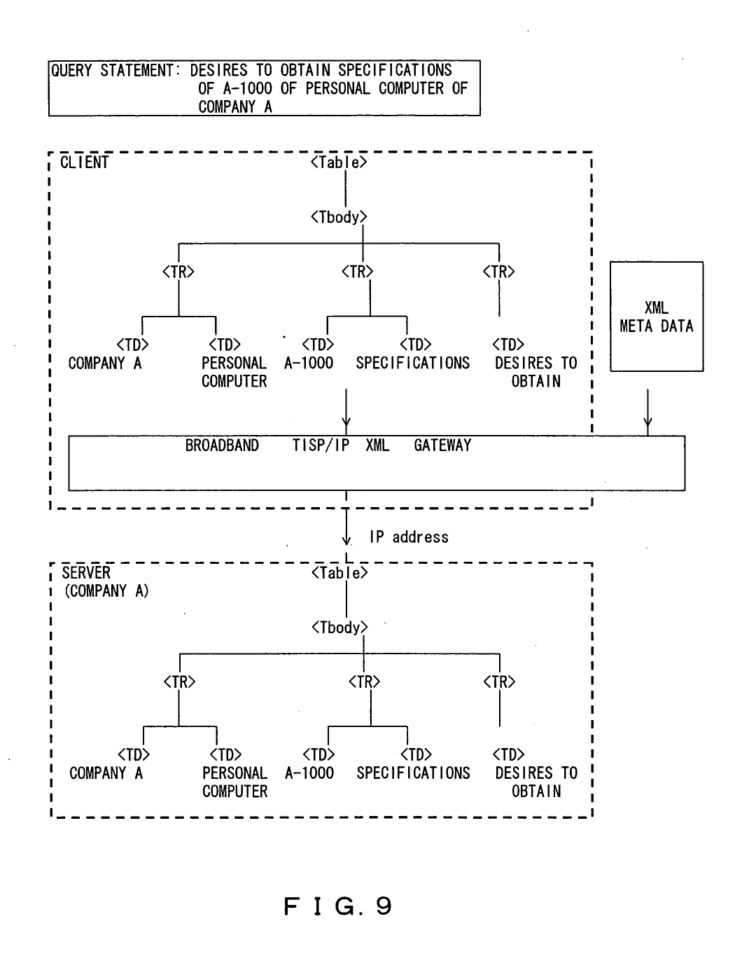

In FIG. 8, when a query statement for searching for the information A is input with the server 1b that operates as a client, a tag generating unit 21 interprets the meaning of the query statement with a dictionary 22, and generates tags. Then, a referencing unit 23 searches for the corresponding meta data by using “a company tag” among the generated tags as a key. If the meta data A hits at this time, the URL (1a) corresponding to the meta data A is obtained. Then, a transferring unit 24 transfers the tags generated by the tag generating unit 21 to the obtained URL. In this way, the query statement written with the tags is transferred to the server 1a. The sequence where the input query statement is transferred is shown in FIG. 9.

A detecting unit 25 within the agent 4 of the server 1a searches for the tree structure of the registration information DB 3a by using the received tags as keys. As a result, the link data A corresponding to the meta data A is extracted. Then, an accessing unit 26 accesses the storage device 2a based on the link data A. Consequently, the server 1a provides the information A extracted with this access to the client.

Another embodiment of the information searching system is described next. In the embodiment explained below, a corresponding IP address (IPv6 address) is assigned to each piece of information stored in a server. Note that each IP address is assigned under a predetermined rule (ontology). as a key

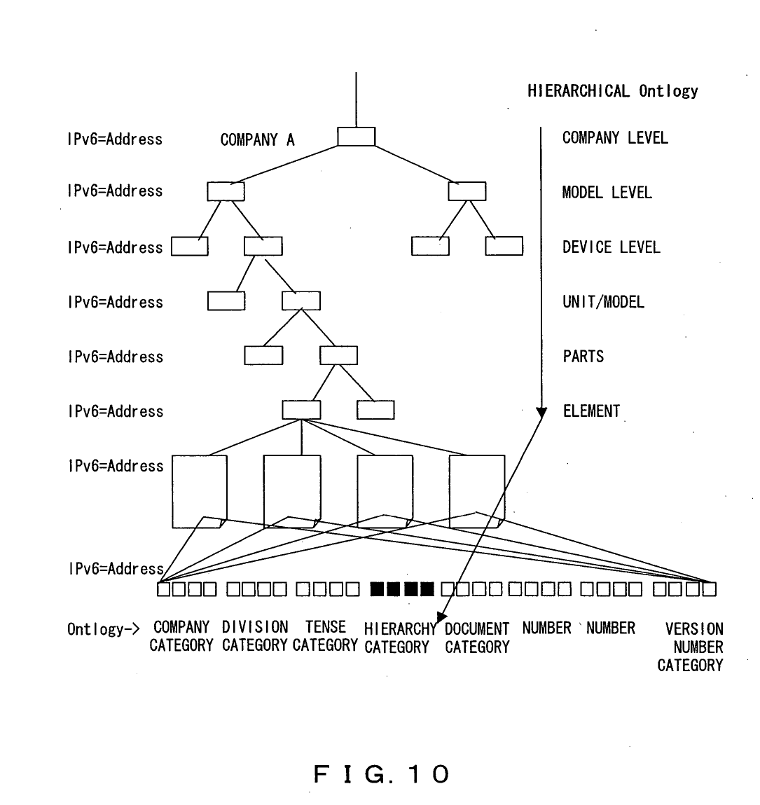

FIG. 10 explains the hierarchical structure of registration information, and IP address assignment. In this example, an IP address is assigned according to “company category”, “division category”, “tense category”, “hierarchy category”, “document category”, “number”, and “version number category”. Here, the “company category” identifies a company. The “division category” represents an organization of the company, and identifies, for example, factory, headquarters, division, department, etc. The “tense category” represents an operational process, and identifies, for example, a planning phase, a design phase, a manufacturing phase, etc. The “hierarchy category” represents a target object, and identifies, for example, a model, a device, a unit, parts, an element, etc. The “document category” represents the type of a document, and identifies, for example, a drawing, a manual, a document, a standard, etc. The “number” corresponds to a serial number. The “version number category” corresponds to the number of times that information is updated. Note that the “company category” is higher-order bits among the “company category” to the “version number category”, and the “division category” to the “version number category” are lower-order bits. As described above, in this embodiment, an IP address is uniquely assigned to the attributes (the company category to the version number category) of information when the information is stored in a server.

Furthermore, a tree structure in a predetermined hierarchical structure is generated as the registration information of information stored in a server. This tree structure represents the route for tracing from the highest level (company name) to the corresponding information, and is written with an XML.

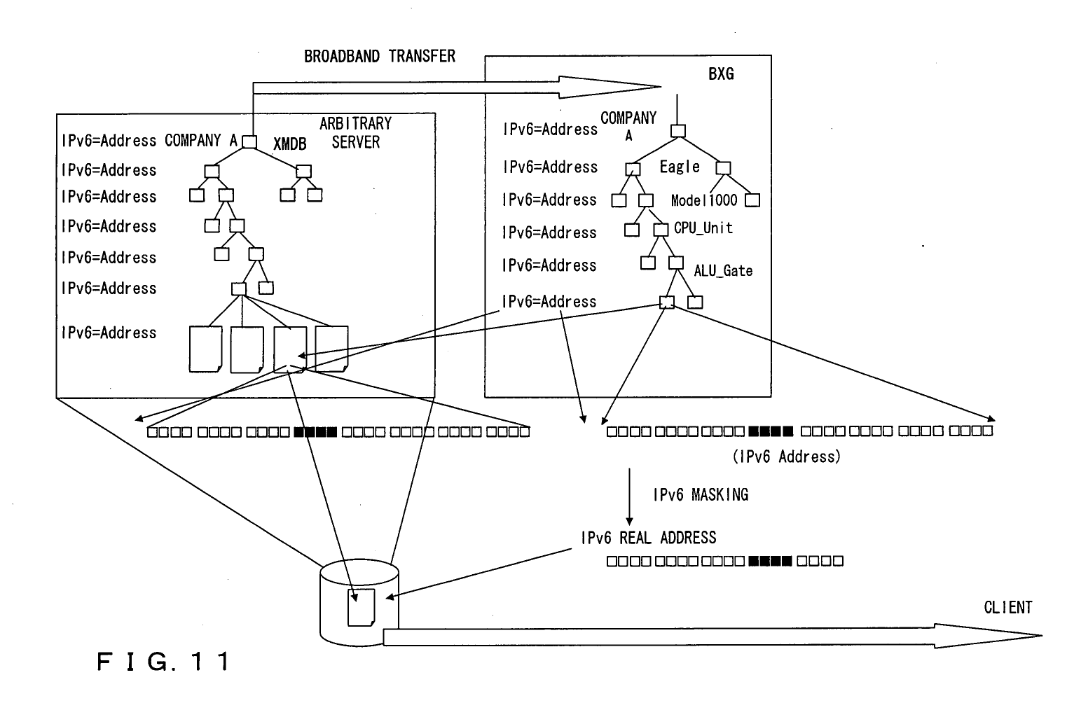

Registration information and a corresponding IP address are broadcast to the other servers as shown in FIG. 11. Then, each of the servers sets the received registration information and the corresponding IP address in the gateway 5 within the server itself. As a result, the registration information of information stored in an arbitrary server and its IP address are shared by all of the servers.

Accordingly, in this system, information is searched with the following sequence. Namely, when a query statement is input with a server that operates as a client, contents of the query statement are interpreted. Then, the tree structure represented by the registration information set in the gateway 5 is traced based on the contents of the query statement, so that the corresponding IP address is extracted. Then, the client obtains the information corresponding to the query statement by directly accessing the storage device 2 of the corresponding server with the IP address.

Remember that the bits of an IP address, which are not designated by a query statement, are masked. For example, if only a “company name”, a “hierarchy category (target commodity)”, and a “document category” are written in a query statement, bits corresponding to these categories are set, and the other bits are masked.

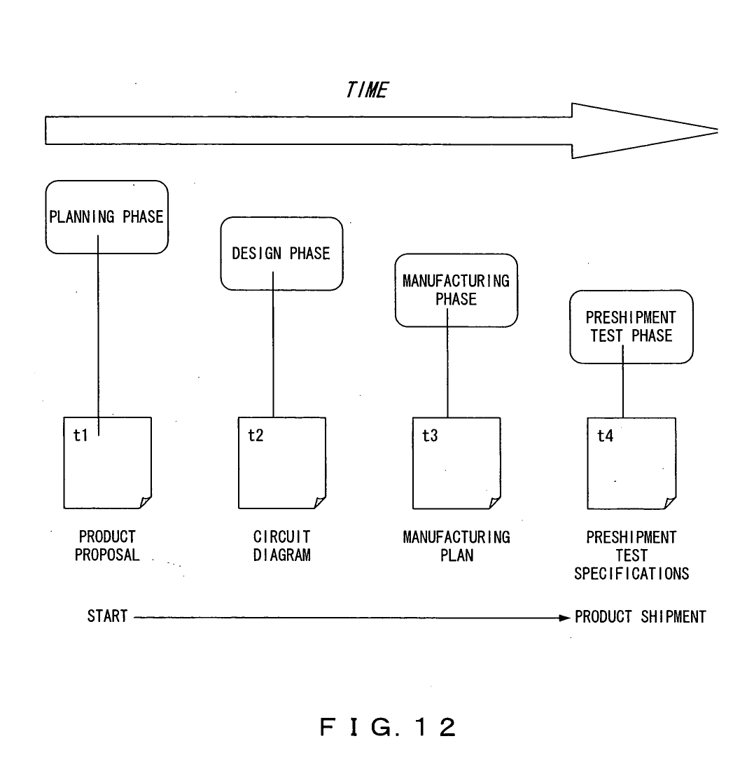

Meanwhile, commodity development normally includes various operational processes such as planning to marketing as shown in FIG. 12. For each of the operations processes, each type of document is generated. For example, a proposal at a planning phase, a design drawing, a circuit diagram, etc. at a design phase, a manufacturing plan, an operation schedule, etc. at a manufacturing phase, test specifications, etc. at a preshipment test phase are respectively generated. These documents are stored in a server as electronic data so that employees of a local company or an associated company can view the documents.

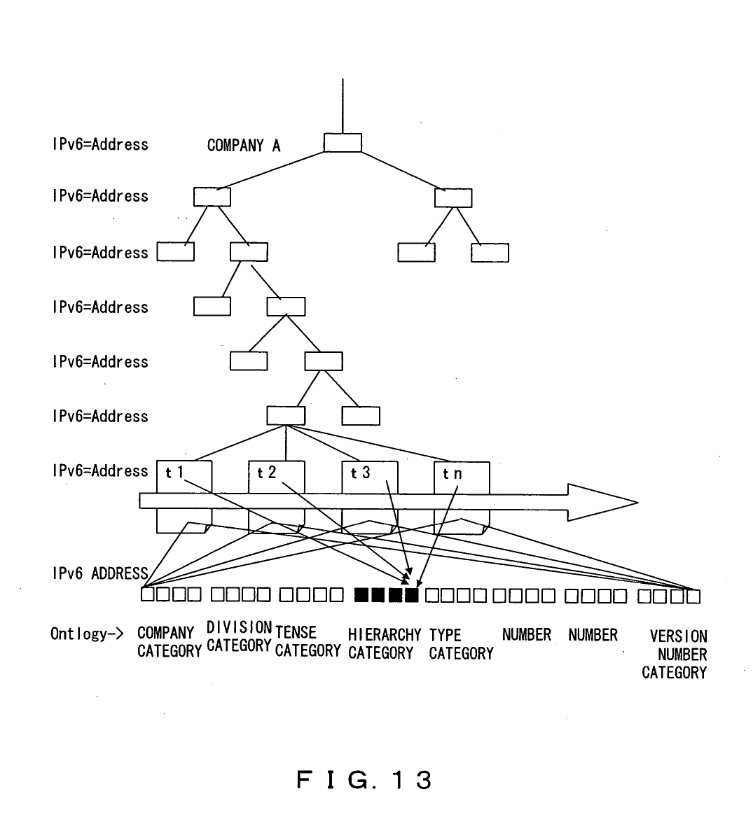

In the system according to this embodiment, a hierarchical structure is defined as described above in order to efficiently search for information generated in time series for one commodity. Specifically, predefined bit values of an IP address are determined based on an operational process as shown in FIG. 13.

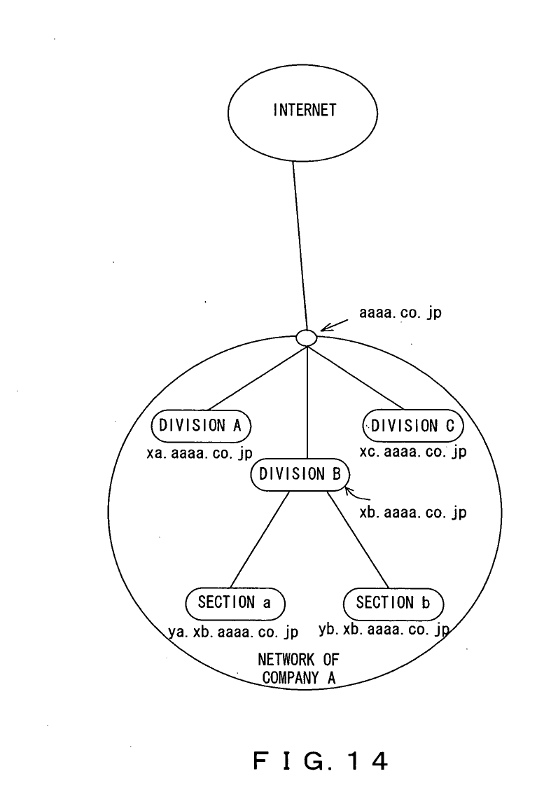

Some companies that publish a Web page have a URL for each organization within the company. For instance, in the example shown in FIG. 14, URLs are respectively assigned to divisions A to C within a company A, and besides, URLs are respectively assigned to sections a and b within the division B.

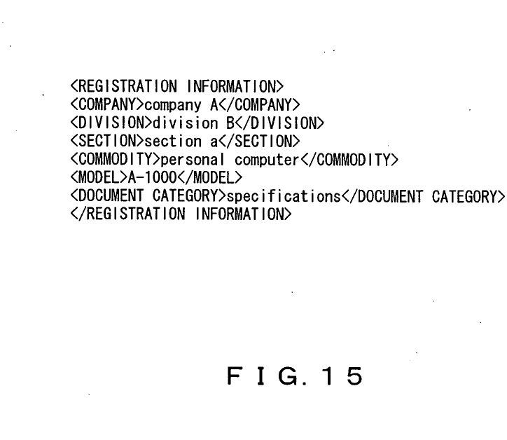

In this case, assuming that information is managed for each of the divisions or each of the sections, a tag for identifying a division or a tag for identifying a section can be written in the meta data of each information. The example shown in FIG. 15 represents the meta data generated when the specifications of A-1000 of personal computer, which is produced in the section a within the division B of the company A, is registered to the server of the section a.

In the meta data shown in FIG. 15, “aaaa.co.jp” may be embedded in association with the company tag, “xb.aaaa.co.jp” may be embedded in association with the division tag, and “ya.xb.aaaa.co.jp” may be embedded in association with the section tag. In this case, if a query statement includes the “company A”, the query statement is transferred to “aaaa.co.jp” by a server that receives the meta data. Similarly, if the query statement includes the “company A” and the “division B”, the statement is transferred to “xb.aaaa.co.jp”. Furthermore, if the query statement includes the “company A”, the “division B”, and the “section a”, the statement is transferred to “ya.xb.aaaa.co.jp”. Then, the server that receives this query statement extracts corresponding information, and provides the extracted information to the client. With this method, information search can be made more efficiently.

A method for visualizing the hierarchical structure of information stored in a server is described next. Here, assume that the meta data of each information stored in a server is written in an XML with the above described method.

When the hierarchical structure (tree structure) of an XML document is analyzed, for example, a DOM (Document Object Model) is used. The DOM is a module that reads the whole of an XML document, and analyzes the document by recognizing the elements, the attributes, character data, etc. of the XML document as a tree structure.

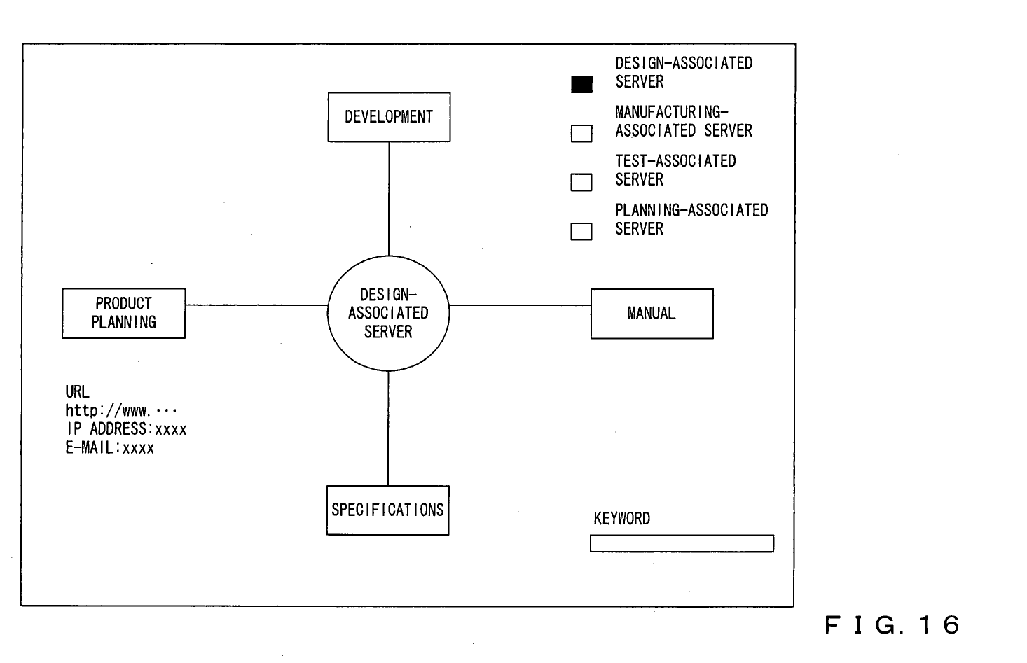

FIG. 16 exemplifies a display of the hierarchical structure of information stored in a server. This display is generated according to an instruction from a user (especially, an administrator of this information searching system). Namely, in the example shown in FIG. 16, information stored in a desired server is displayed when a user selects the desired server from among a plurality of server groups. Or, when a keyword is input from a user, the agent 4 extracts the meta data including the keyword from the registration information (meta data group) stored in the registration information DB 3. Here, the meta data is XML tags. Then, the agent 4 extracts, with the DOM, a first tag that corresponds to the input keyword, and one or a plurality of second tags that belong to a level immediately below the first tag. Then, the element of the first tag that corresponds to the keyword is displayed in the center of the screen, and the elements in the hierarchy immediately below the hierarchy including the first tag are displayed to surround the element of the first tag. For each of the elements, a URL, an IP address, an e-mail address of a document creator, etc. may be displayed at the same time as occasion demands. In this case, it is assumed that these items of information are registered in advance.

In the display example shown in FIG. 16, only one index cell (index cell: one element and the elements of its immediately below level) is displayed on the screen. However, a plurality of index cells may be displayed at the same time. Additionally, each index cell can be freely moved, or expanded/reduced according to a mouse operation. Furthermore, index cells can be combined.

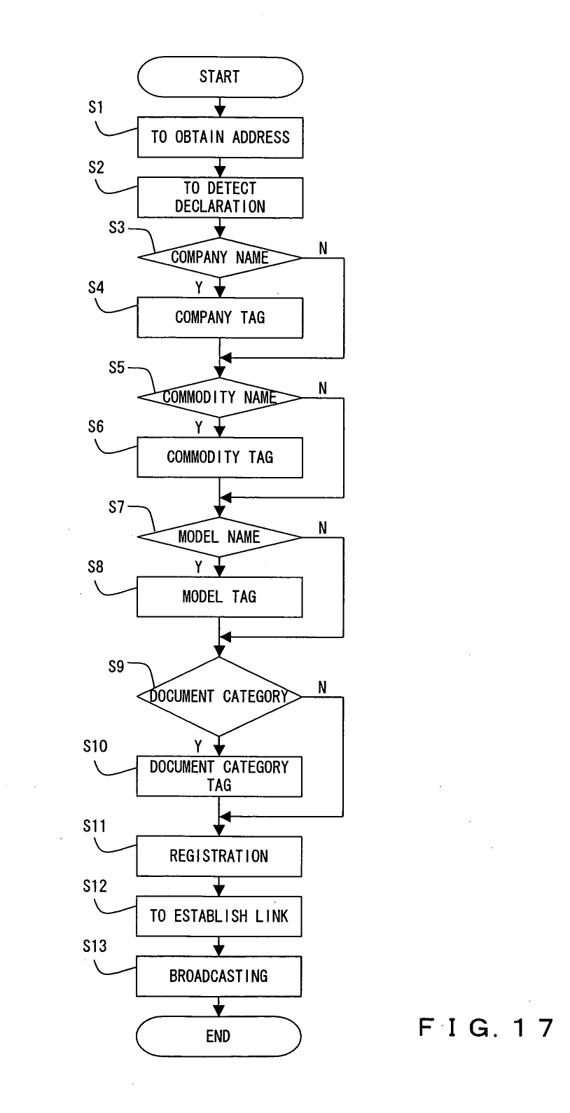

Operations of a server are described with reference to the flowcharts shown in FIGS. 17 to 19. The following description assumes that information stored in the server belongs to the hierarchical structure shown in FIG. 4.

FIG. 17 is a flowchart showing the process for generating and broadcasting meta data. The process represented by this flowchart is executed when information is stored in the storage device 2.

In step S1, the storage address of information is obtained. In step S2, a declaration made by a user is detected for the above described information. In steps S3 and S4, it is examined whether or not a “company name” is declared. If the “company name” is declared, a company tag the element of which is the company name is generated. Similarly, in steps S5 and S6, a commodity tag is generated. In steps S7 and S8, a model tag is generated. In steps S9 and S10, a document category tag is generated. In this way, for example, the XML document shown in FIG. 4 is generated.

In step S11, the XML document generated in steps S3 to S10 is registered to the registration information DB 3 as the meta data of the information stored in the storage device 2. In step S12, a link from the meta data registered in step S11 to the storage address obtained in step S1 is established. The link is as explained with reference to FIG. 5. Then, in step S13, the meta data registered to the registration information DB 3 is broadcast to all of the other servers. At this time, the URL of the corresponding server is assigned to this meta data. As a result, the servers share the meta data of the information stored in the storage device 2.

In the above described embodiment, meta data is generated based on a declaration made by a user. However, the present invention is not limited to this implementation. For example, when information is written from a certain terminal to the storage device 2, one or a plurality of tags may be automatically generated based on an identifier for identifying the terminal, or the like.

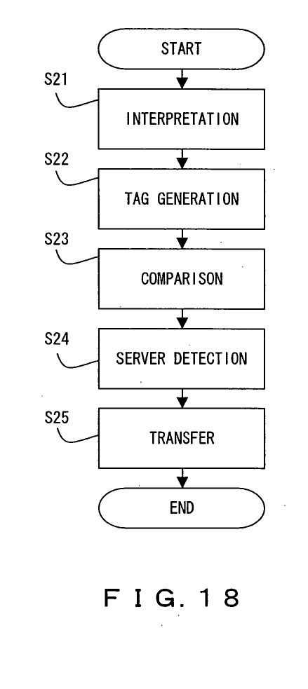

FIG. 18 is a flowchart showing the process for transferring an input query statement to a corresponding server. The process represented by this flowchart is executed when a query statement as a search request is input by a user.

In step S21, the input query statement is broken down into a plurality of words, and the meanings of the words are interpreted. In step S22, XML tags that respectively correspond to the words are generated. Here, the basic operations are the same as those in steps S3 to S10 of FIG. 17. Accordingly, if the query statement includes a “company name”, a “commodity name”, a “model”, and a “document category”, then a company tag, a commodity tag, a model tag, and a document category tag are respectively generated.

In step S23, a comparison is made between the XML tags generated in step S22 and meta data transferred form other server. Then, meta data that matches the XML tags generated in step S22 is extracted. In step S24, a URL assigned to the meta data, which is extracted in step S23, is detected. Then, in step S25, the XML tags generated in step S22 are transferred to the detected URL. In this way, the query statement input by the user is transferred to the source server of the meta data corresponding to the query statement.

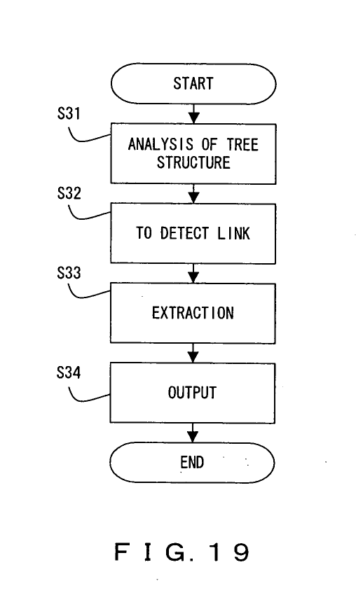

FIG. 19 is a flowchart showing the process for providing information according to a query statement. The process represented by this flowchart is executed when a query statement is received from other server.

In step S31, an access is made to the registration information DB 3 by using as a key a query statement that is received from other server and configured by XML tags. Here, a meta data group stored in the registration information DB 3 represents the tree structure of information stored in the storage device 2. Namely, in step S31, the tree structure is analyzed based on the query statement. In step S32, a link established for the analysis result of the tree structure is detected. This link is, as explained with reference to FIG. 5, and designates the storage location of the information corresponding to the query statement.

In step S33, the information is extracted from the storage device 2 by using the link detected in step S32. Then, in step S34, the extracted information is provided.

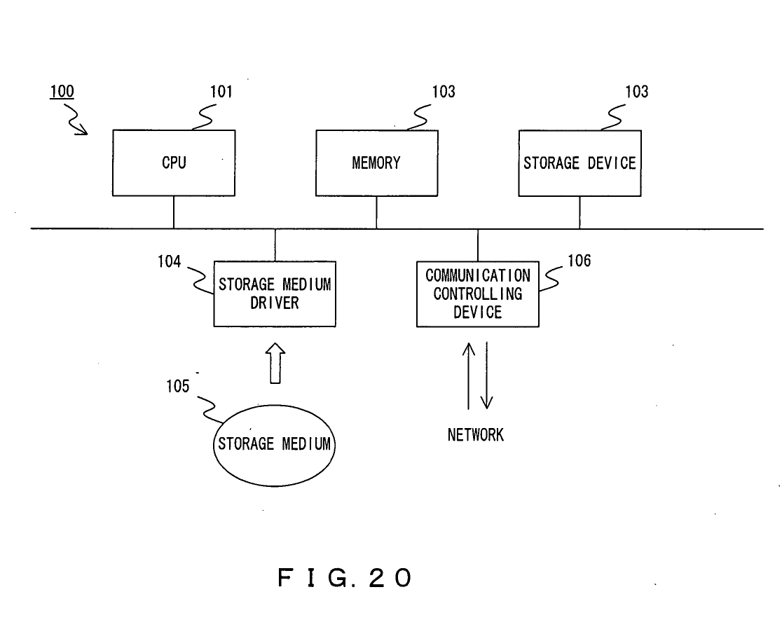

The functions of the information searching system according to the embodiment are implemented by executing a program that describes the processes stated earlier with the use of a computer. A block diagram showing the computer executing the program is shown in FIG. 20.

A CPU 101 obtains the program that describes the processes represented by the above described flowcharts from a storage device 102, a program server, or the like, and executes the program. The storage device 102 is, for example, a hard disk, and stores the above described program. Note that information to be searched may be stored in the storage device 102 or another storage device connected to this computer. A memory 103 is, for example, a semiconductor memory, and is used as the working area of the CPU 101.

A storage medium driver 104 accesses a portable storage medium 105 according to an instruction of the CPU 101. The portable storage medium 105 includes, for example, a semiconductor device (PC card, memory stick, etc.), a medium (flexible disk, magnetic tape, etc.) to/from which information is input/output with a magnetic operation, and a medium (optical disk, etc.) to/from which information is input/output with an optical operation. A communication controlling device 106 transmits a signal to a network according to an instruction of the CPU 101, and receives a signal from the network.

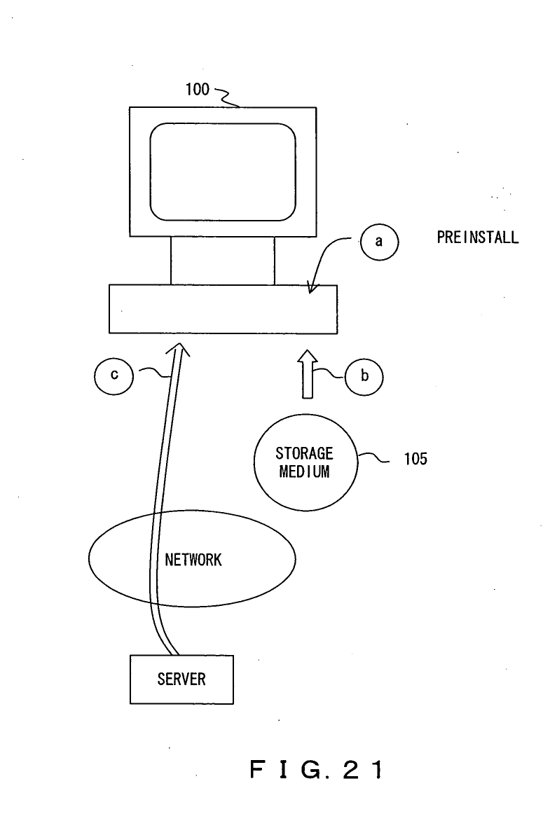

FIG. 21 explains a method providing a software program according to the present invention. The program according to the present invention is provided with an arbitrary one of the following methods.

(a) Installed in the computer 100, and provided. In this case, the program is installed in advance, for example, prior to shipment.

(b) Stored onto a portable storage medium, and provided. In this case, the program stored onto the portable storage medium 105 is fundamentally installed in the storage device 102 via the storage medium driver 104.

(c) Provided from a program server on a network. In this case, the computer 100 fundamentally obtains the program stored in the program server by downloading.

What is claimed is:

1. An information searching system having a plurality of information providing servers, each of the plurality of information providing servers comprising:
a storage device which stores information;
a generating unit generating meta data which represents an attribute of the information stored in said storage device;
a transferring unit transferring the meta data generated by said generating unit to other information providing server;
a detecting unit detecting an information providing server which corresponds to a given query statement based on the meta data transferred from other information providing server;
a query statement transferring unit transferring the query statement to the information providing server detected by said detecting unit; and
an extracting unit extracting information requested by the query statement, which is transferred from other information providing server, from said storage device based on the meta data generated by said generating unit.

2. The information searching system according to claim 1, wherein
the meta data is written in XML.

3. The information searching system according to claim 1, wherein:
said generating unit establishes a link from the meta data to the information stored in said storage device; and
said extracting unit accesses said storage device by using the link.

4. The information searching system according to claim 1, wherein:
said transferring unit assigns identification information for identifying a corresponding information providing server to the meta data, when transferring the meta data to other information providing server; and
said detecting unit detects the information providing server corresponding to the query statement based on the identification information.

5. The information searching system according to claim 1, wherein
said detecting unit converts the query statement into an XML document, and detects an information providing server which corresponds to the XML document.

6. The information searching system according to claim 1, further comprising
a displaying unit displaying a relationship, at least, among some of a plurality of pieces of information stored in said storage device based on a plurality of pieces of meta data, if the plurality of pieces of information are stored in said storage device, and the plurality of pieces of corresponding meta data are generated by said generating unit.

7. An information providing server used in an information searching system having a plurality of information providing servers, comprising:
a storage device which stores information;
a generating unit generating meta data which represents an attribute of the information stored in said storage device;
a transferring unit transferring the meta data generated by said generating unit to other information providing server;
a detecting unit detecting an information providing server which corresponds to a given query statement based on the meta data transferred from other information providing server;
a query statement transferring unit transferring the query statement to the information providing server detected by said detecting unit; and
an extracting unit extracting information requested by the query statement, which is transferred from other information providing server, from said storage device based on the meta data generated by said generating unit.

8. The information providing server according to claim 7, wherein
the meta data is written in XML.

9. The information providing server according to claim 7, wherein:
said generating unit establishes a link from the meta data to the information stored in said storage device; and
said extracting unit accesses said storage device by using the link.

10. The information providing server according to claim 7, wherein:
said transferring unit assigns identification information for identifying a corresponding information providing server to the meta data, when transferring the meta data to other information providing server; and
said detecting unit detects the information providing server corresponding to the query statement based on the identification information.

11. The information providing server according to claim 7, wherein
said detecting unit converts the query statement into an XML document, and detects an information providing server which corresponds to the XML document.

12. The information providing server according to claim 7, further comprising
a displaying unit displaying a relationship, at least, among some of a plurality of pieces of information stored in said storage device based on a plurality of pieces of meta data, if the plurality of pieces of information are stored in said storage device, and the plurality of pieces of corresponding meta data are generated by said generating unit.

13. A method of searching for information in a system having a plurality of information providing servers, comprising:
generating meta data which represents an attribute of information, when the information is stored in a first information providing server;
transferring the meta data from the first information providing server to a second information providing server;
detecting an information providing server corresponding to a given query statement based on the meta data transferred from the first information providing server, when the query statement is input with the second information providing server;
transferring the query statement from the second information providing server to the first information providing server, if the information providing server corresponding to the query statement is the first information providing server; and
extracting information requested by the query statement, which is transferred from the second information providing server, by the first information providing server based on the generated meta data.

14. A method of searching for information in a system having a plurality of information providing servers, comprising:
generating meta data which represents an attribute of information, when the information is stored in a first information providing server;
broadcasting the meta data from the first information providing server to other information providing servers;
transferring a query statement from a second information providing server to the first information providing server according to the received meta data, when the query statement is input with the second information providing server; and
providing information corresponding to the query statement by the first information providing server.

15. A method of providing information corresponding to a query statement by a first information providing server among a plurality of information providing servers in an information searching system having the plurality of information providing servers, comprising:
generating meta data which represents an attribute of information, when the information is stored in a storage device;
establishing a link from the generated meta data to a storage location of the information;
transferring the generated meta data to a second information providing server;
receiving a query statement from the second information providing server, if an attribute of information requested by the query statement, which is input with the second information providing server, matches the attribute of information represented by the meta data; and
extracting information requested by the received query statement from the storage device by using the established link.

16. A searching method with which a first information providing server among a plurality of information providing servers processes a query statement for information search in an information searching system having the plurality of information providing servers, comprising:
receiving meta data which represents an attribute of information stored in a second information providing server from the second information providing server; and
requesting information search by transferring a given query statement to the second information providing server, if an attribute of information requested by the query statement matches the attribute represented by the meta data.

17. An information providing program, which is intended to provide information corresponding to a query statement in an information searching system having a plurality of information providing servers, for enabling a computer to provide:
a generating unit generating meta data which represents an attribute of information, when the information is stored in a storage device;
an establishing unit establishing a link from the generated meta data to a storage location of the information;
a transferring unit transferring the meta data generated by said generating unit to other information providing server;
a receiving unit receiving a query statement from other information providing server, if an attribute of information requested by the query statement input with other information providing server matches the attribute represented by the meta data; and
an extracting unit extracting information requested by the received query statement with the use of the link established by said establishing unit.

18. An information searching program, which is intended to process a query statement for information search in an information searching system having a plurality of information providing servers, for enabling to provide:
a receiving unit receiving meta data which represents an attribute of information stored in a first information providing server from the first information providing server; and
a requesting unit requesting information search by transferring a given query statement to the first information providing server, if an attribute of information requested by the query statement matches the attribute represented by the meta data.

19. The information providing server according to claim 10, wherein
an information sequence, which is generated with a flow of operations, is sequentially registered on a time axis according to operational processes in time series logic, and search is made in time series.

20. The method according to claim 13, wherein,
an information sequence, which is generated with a flow of operations, is sequentially registered on a time axis according to operational processes in time series logic, and search is made in time series.

21. The method according to claim 16, further comprising:
classifying the plurality of servers into groups by field; and
visualizing an overview of an information search target server or a database group in a field associated with an arbitrary group, when the arbitrary group among the groups is selected.

22. An information searching system having a plurality of information providing servers, comprising:
a storage device, provided in a first information providing server, for storing information;
a generating unit, provided in the first information providing server, for generating meta data which represents an attribute of the information stored in said storage device;
a transferring unit, provided in the first information providing server, for transferring the meta data generated by said generating unit to a second information providing server;
a detecting unit, provided in the second information providing server, for detecting an information providing server which corresponds to a given query statement based on the meta data transferred from the first information providing server;
a query statement transferring unit, provided in the second information providing server, for transferring the query statement to the first information providing server, when the first information providing server is detected by said detecting unit; and
an extracting unit, provided in the first information providing server, for extracting information requested by the query statement, which is transferred from the second information providing server, from said storage device based on the meta data generated by said generating unit.

23. An information providing server used in an information searching system having a plurality of information providing servers, comprising:
storing means for storing information;
generating means for generating meta data which represents an attribute of the information stored in said storing means;
transferring means for transferring the meta data generated by said generating means to other information providing server;
detecting means for detecting an information providing server which corresponds to a given query statement based on the meta data transferred from other information providing server;
query statement transferring means for transferring the query statement to the information providing server detected by said detecting means; and
extracting means for extracting information requested by the query statement, which is transferred from other information providing server, from said storing means based on the meta data generated by said generating means.
